(19) United States
(12) Patent Application Publication
(10) Pub. No.: US 2026/0340583 A1
(43) Pub. Date: Oct. 29, 2026

(54) SYSTEM FOR INVENTORYING OBJECTS CONTAINED IN A SPACE DELIMITED BY AN ENCLOSURE

(71) Applicant: NEXESS, Valbonne Sophia Antipolis (FR)

(72) Inventors: Richard KELLY, Valbonne Sophia Antipolis (FR); Jean-Anaël MONBLANC, Valbonne Sophia Antipolis (FR)

(73) Assignee: NEXESS, Valbonne Sophia Antipolis (FR)

(21) Appl. No.: 19/118,299

(22) PCT Filed: Oct. 9, 2023
(86) PCT No.: PCT/EP2023/077915

§ 371 Date: Apr. 3, 2025

(30) Foreign Application Priority Data
Oct. 12, 2022 (FR) FR2210494

(51) Int. Cl. G06Q 10/087; G06M 11/00

(52) U.S. Cl. CPC G06Q 10/08772; G06M 11/00

(57) ABSTRACT

A system for inventorying objects contained in a closed space delimited by an enclosure, including at least one electronic card, the electronic card includes a plurality of sensors, each sensor consisting of an electronic circuit composed of an inductor and a capacitor, activating measurements of at least one characteristic of at least one set of electronic circuits composed of an inductor and a capacitor, activating a comparison of each measured characteristic with a determined reference characteristic, and activating a determination of the presence of an object according to at least one comparison result.

### TECHNICAL FIELD

The present invention relates to a system for inventorying objects contained in a space delimited by an enclosure using eddy-current technology as well as an inventorying method implemented by such an inventorying system.

### PRIOR ART

Systems for inventorying objects contained in a delimited space using RFID technology are known. In general terms, a system using RFID technology consists of three types of element:
at least one transponder, also referred to as a tag, consisting of an electronic circuit provided with an antenna for sending and receiving data in the form of radio-frequency waves, the circuit comprising at least one memory in which an identifier of said transponder is stored,
a reading point also consisting of an electronic circuit provided with an antenna for sending and receiving data, also in the form of radio-frequency waves, and
a control unit connected to the reading point and using an application.

The operation of such an RFID system is as follows. At the commencement of the identification procedure, the reading point sends a modulated electromagnetic wave referred to hereinafter as a wake-up wave, intended for each tag in the system. On reception of same, a tag, located in a coverage area where the electromagnetic field generated by the reading point is at a sufficiently high level, is electrically supplied by the electromagnetic wave, emerges from its standby state, becomes active and then sends identification data that is particular to it in the form of a modulated electromagnetic wave. This identification data is received by the reading point, which then proceeds to identify the tag in question.

In the application to an inventory system envisaged here, each tag is attached to an object, such as a tool used for maintaining a workshop, a factory, etc. The objects to be inventoried are stored in a closed space, such as a cabinet, a bench or a cupboard. This closed space is subdivided into a plurality of closed sub-spaces such as for example shelves, drawers, etc.

Objects that do not have a sufficiently large surface to which it is possible to fix a tag, or tools that do not have an unused/non-curved surface, or objects the tag of which does not allow good reliability of detection, cannot be inventoried by an RFID system. For example, in an industrial environment, such objects are wrenches, screwdriver ends, Allen keys and universal joints.

The aim of the present invention is to solve the drawbacks of the prior art by proposing a method and a system for inventorying, in a closed space delimited by an enclosure, objects that do not have a sufficiently large surface to which it is possible to fix a tag, or objects not having an unused/non-curved surface, or objects the tag of which does not allow good reliability of detection contained in a closed space delimited by an enclosure.

### DISCLOSURE OF THE INVENTION

For this purpose, the invention relates to a method for inventorying objects contained in a closed space delimited by an enclosure, the closed space comprising at least one closed sub-space, the at least one closed sub-space comprising an electronic card on which a mount is placed comprising recesses for receiving objects to be inventoried comprising at least one metallic portion, at least some of the recesses being conformed to receive respectively an object, the system comprising a control device able to determine whether all the objects are included in the closed space, characterised in that the electronic card comprises a plurality of sensors, each sensor consisting of an electronic circuit composed of an inductor and a capacitor, and in that the method comprises the steps, performed by a microcontroller of the electronic card, of:
receiving a command from the control device to make measurements,
activating measurements of at least one characteristic of at least one set of electronic circuits composed of an inductor and a capacitor,
activating a comparison of each measured characteristic with a determined reference characteristic for each electronic circuit composed of an inductor and a capacitor,
activating a determination of the presence of an object according to at least one comparison result,
transferring, to the control device, a frame comprising, for each electronic circuit in the set of electronic circuits composed of an inductor and an active sensor capacitor, information representing the detection or not of the presence of the small objects.

The invention also relates to a system for inventorying objects contained in a closed space delimited by an enclosure, the closed space comprising at least one closed sub-space, the at least one closed sub-space comprising an electronic card on which a mount is placed comprising recesses for receiving objects to be inventoried comprising at least one metallic portion, at least some of the recesses being conformed to receive respectively an object, the system comprising a control device able to determine whether all the objects are included in the closed space, characterised in that the electronic card comprises a plurality of sensors, each sensor consisting of an electronic circuit composed of an inductor and a capacitor, and in that the electronic card furthermore comprises:
means for receiving a command from the control device to make measurements,
means for activating measurements of at least one characteristic of at least one set of electronic circuits composed of an inductor and a capacitor,
means for activating a comparison of each measured characteristic with a determined reference characteristic for each electronic circuit composed of an inductor and a capacitor,
means for activating a determination of the presence of an object according to at least one comparison result,
means for transferring, to the control device, a frame comprising, for each electronic circuit in the set of electronic circuits composed of an inductor and an active sensor capacitor, information representing the detection or not of the presence of the small objects.

Thus it is possible to make an inventory of objects that do not have a sufficiently large surface to which it is possible to fix a tag, or of objects that do not have an unused/non-curved surface, or objects the tag of which does not allow good reliability of detection.

According to a particular embodiment, each sensor is respectively disposed on the electronic card at an intersection of a horizontal line and of a vertical line, the vertical and horizontal lines being spaced apart regularly.

Thus the present invention makes it possible to make an inventory on a large number of objects without the need for sensors adapted to the size of the object to be inventoried. Great flexibility of positioning of the tools is allowed, while being modular at a controlled cost.

According to a particular embodiment, the system comprises:
means for measuring the temperature in the closed sub-space, the reference characteristic determined for each electronic circuit composed of an inductor and capacitor being obtained from a measurement of the characteristic when the mount comprising recesses is empty,
means for storing the temperature measured during the measurement of the characteristic when the mount comprising recesses is empty and during the measurement of the characteristic when the mount comprising recesses is empty.

According to a particular embodiment, the temperature of the closed sub-space is measured during the measurement of the characteristic of at least some of the electronic circuits composed of an inductor and a capacitor, the reference characteristic being determined in accordance with the following formula:

$$Zcomp = Zref * ( 1 + ( Tact - Tref ) * Tcoefft )$$

where Tcoefft is a previously memorised stored configuration variable, Zref is the measurement of the characteristic when the mount comprising recesses is empty, Tref is the temperature measured during the measurement of the characteristic when the mount comprising recesses is empty and Tact is the temperature measured when the means for measuring the characteristic are activated.

Thus it is possible to ensure a precise measurement making it possible to operate with a small tolerance (Tol) essential to the differentiation of the objects and the monitoring of very small objects, and this whatever the variation in temperature of the environment of the system. In addition, this precise measurement allows the detection of a non-metallised object but which has a metallic coating.

According to a particular embodiment, the control device is connected to a UHF RFID reader disposed on the closed space, the UHF RFID reader being provided with at least one antenna, not shown, which emits electromagnetic waves intended for RFID tags. Thus it is possible to ensure the monitoring, in the same closed space, of small tooling objects and of larger objects provided with RFID tags.

According to a particular embodiment, the characteristic is a parallel impedance and/or a frequency.

### BRIEF DESCRIPTION OF THE DRAWINGS

The features of the invention mentioned above, as well as others, will emerge more clearly from the reading of the following description of example embodiments, said description being made in relation to the accompanying drawings, among which:

FIG. 1 is a schematic view of a system for inventorying a bench in which the present invention is implemented;

FIG. 2 is an example of architecture of the inventory system according to the present invention;

FIG. 3 is an example of a mount comprising recesses for receiving objects to be inventoried according to the present invention;

FIG. 4 is an example of architecture of a microcontroller able to manage the operation of sensors for making an inventory of objects in a closed sub-space;

FIG. 5 is an example of a matrix of sensors for determining the presence or absence of objects to be inventoried according to the present invention;

FIG. 6 is a view explaining the principle of detecting an object by eddy current;

FIG. 7 is an example of architecture of an electronic card included in the closed space;

FIG. 8 shows an example of an algorithm executed by a microcontroller in the electronic card included in the closed space according to the present invention.

### DETAILED DISCLOSURE OF EMBODIMENTS

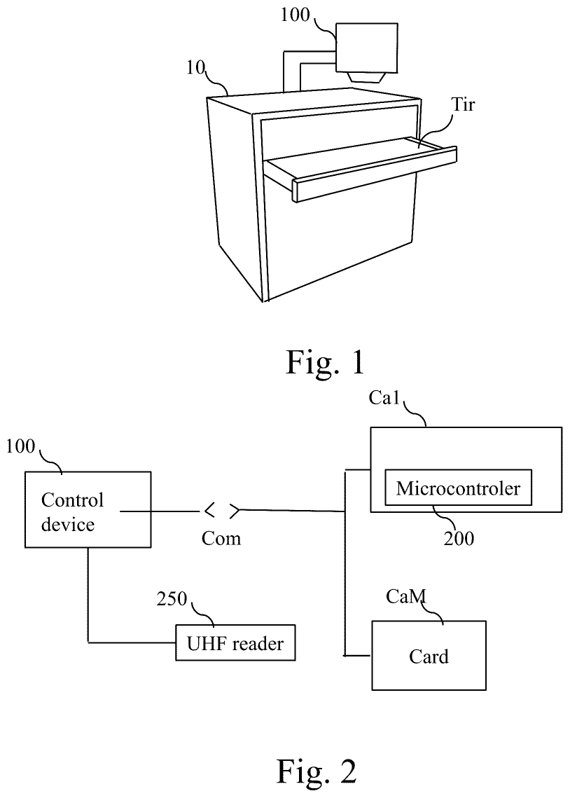

FIG. 1 is a schematic view of an inventory system according to a first embodiment of the present invention.

The inventory system shown in FIG. 1 is designed to inventory objects that are contained in a closed space such as a cabinet 10, a cupboard or a workshop bench, which can contain elements such as shelves or drawers Tir forming closed sub-spaces. This closed space and these closed sub-spaces are respectively delimited by a metal enclosure.

The objects in question are for example tools for maintaining a workshop, a factory, etc. Some of these objects are provided with an RFID (Radio-Frequency IDentification) tag, others, because of their small size, do not have an RFID tag.

The objects not having an RFID tag will hereinafter be referred to as small objects.

The inventory system comprises a control device 100.

FIG. 2 is an example of architecture of the inventory system according to the present invention.

The control device 100 is connected to a UHF RFID reader 250 disposed on the closed space 10. The UHF RFID reader 250 is provided with at least one antenna, not shown, which emits electromagnetic waves intended for RFID tags. The control device 100 is for example a computer, a smartphone or a touch-screen tablet.

According to the invention, the control device 100 is able to generate requests to at least one microcontroller 200 of an electronic card included in a closed sub-space to activate detection of the presence or absence of at least one small object in the closed sub-space in which the electronic card is placed.

The requests and responses of at least one electronic card are transmitted by a wire or radio connection COM.

For example, a first electronic card Ca1 is disposed in a first closed sub-space and a second electronic card Ca2 is disposed in a first closed sub-space. Each electronic card comprises a microcontroller 200.

The control device 100 has a database comprising the objects stored in the closed space. The control device 100 executes a control program and decides on the presence or absence of all the objects, either tagged tools or small objects.

In order to configure the number of mounts comprising recesses and the number of electronic cards, and in order to associate the location of the tools with the detector or detectors, the control device 100 interrogates each electronic card which, in response, transmits to it its unique identifier, the control device 100 establishes a list of electronic cards and associates with each small object the identifier of the electronic card and each position of the sensor or sensors which the small object must be facing.

The control device 100 notifies to each electronic card the list of sensors to be used by the electronic card and each electronic card records the at least one characteristic of the resonant circuit of each sensor to be used when the mount comprising the recesses is empty and the temperature at which the measurement is made.

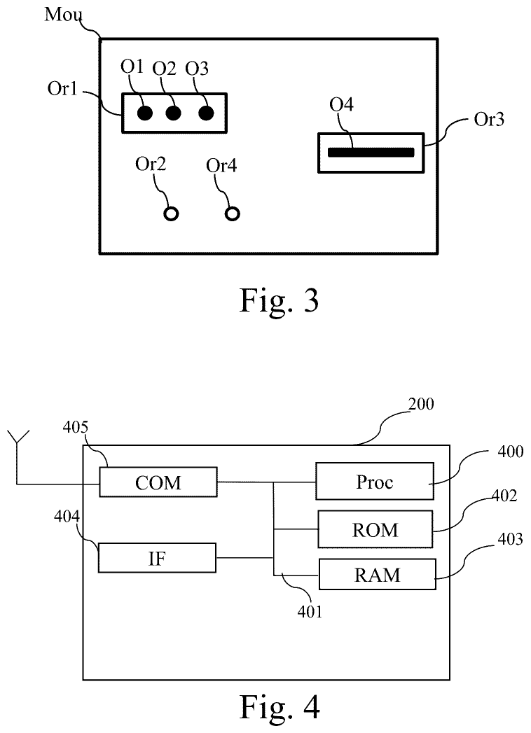

FIG. 3 is an example of a mount comprising recesses for receiving objects to be inventoried according to the present invention.

The mount Mou comprises recesses Or1, Or2, Or3 and Or4 for receiving objects to be inventoried.

The mount Mou is for example a polymer foam.

The recess Or1 is conformed to receive the objects O1, O2 and O3. The recesses Or2 and Or4 are conformed to receive respectively a single object. The recess Or3 is conformed to receive a single object O4.

In the example in FIG. 3, the objects O1, O2, O3 and O4 are respectively present in the recess that is allocated to them. The recesses are adapted to match the shape of the object and are adapted to receive a plurality of objects.

No object is present in the recesses Or2 and Or3.

FIG. 4 is an example of architecture of a microcontroller able to manage the operation of sensors for making an inventory of objects in a closed sub-space.

The microcontroller according to the present invention comprises:
a processor, microprocessor or microcontroller 400;
a volatile memory 403;
a non-volatile memory 402;
an interface I/F for controlling the electronic card 404;
a bidirectional communication interface COM 405;
a communication bus connecting the processor 400 to the ROM memory 402, to the RAM memory 403, to the interface IF 404 and to the communication interface COM 405.

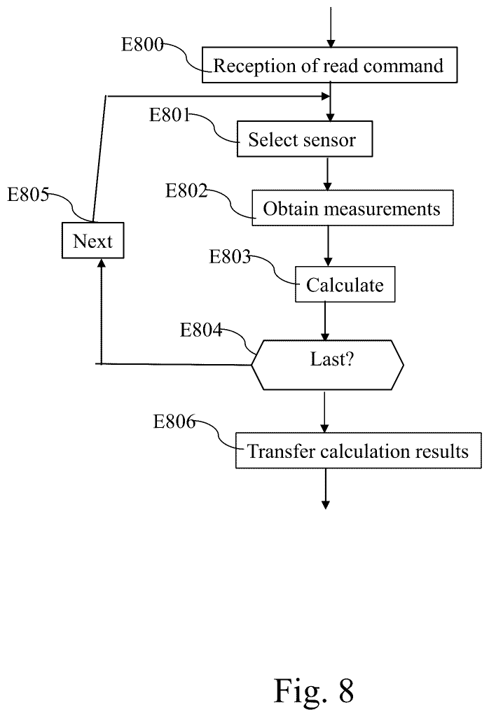

The processor 400 is capable of executing instructions loaded in the volatile memory 403 from the non-volatile memory 402, from an external memory (not shown), from a storage medium, such as an SD card or the like, or from a communication network. When the controller 200 according to the present invention is powered up, the processor 400 is capable of reading instructions from the volatile memory 403 and executing them. These instructions form a computer program that causes the implementation, by the processor 400, of all or part of the method described in relation to FIG. 8.

All or part of the method described in relation to FIG. 8 can be implemented in software form by executing a set of instructions by a programmable machine, such as a DSP (“digital signal processor”) or a microcontroller, or be implemented in hardware form by a machine or a dedicated component, for example an FPGA (field-programmable gate array) or an ASIC (application-specific integrated circuit).

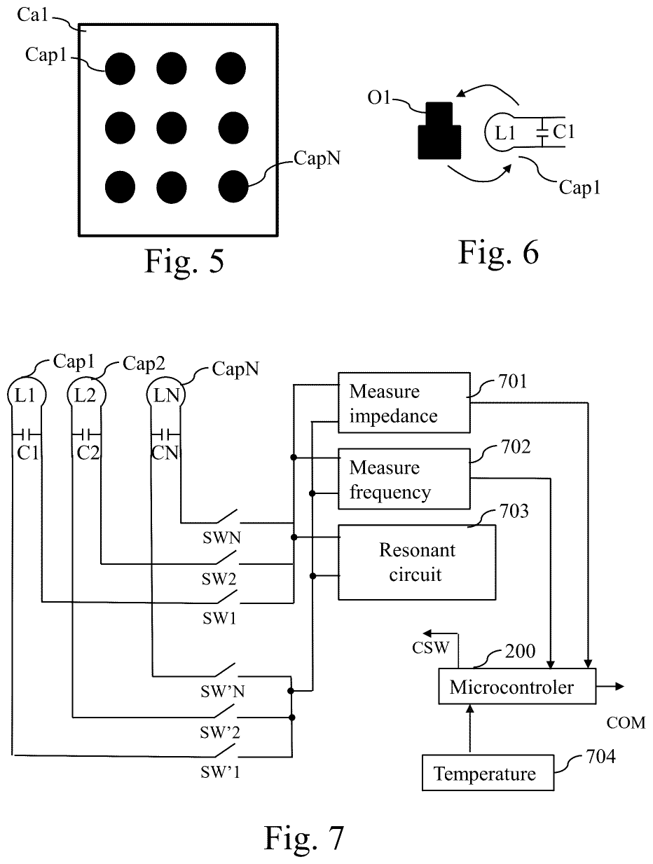

FIG. 5 is an example of a matrix of sensors for determining the presence or absence of objects to be inventoried according to the present invention.

At least one sensor matrix is disposed on each electronic card. In the example in FIG. 5, the sensor matrix is on the electronic card Ca1.

The sensor matrix comprises a plurality of sensors denoted Cap1 to CapN disposed regularly on the surface of the electronic card Ca1.

The electronic card Ca1 is placed below the mount Mou disposed in the drawer Tir.

The sensors are disposed at the intersections of horizontal and vertical lines regularly spaced apart. For example, the horizontal and vertical lines are spaced apart by 3 cm.

This architecture makes it possible to implement electronic cards adapted to any type of small object.

According to the size of the object and its location provided in the mount Mou, one or more sensors can thus be facing said small object.

FIG. 6 is a view explaining the principle of detecting an object by eddy current. A sensor, for example the sensor Cap1, consists of an inductor L1 and a capacitor C1 forming a resonant circuit. The presence of a small object such as the object O1 increases the effective inductance of the resonant circuit and therefore reduces the oscillation frequency. Instead of, or in addition to, the detection is implemented by measuring the change in the characteristic. The microcontroller can measure the frequency and make the comparison between the measured frequency and the reference frequency when the recess is empty. The difference between the values determines whether the tool is present or not.

It is possible to deceive the detection by putting another metal object in the recess. According to the invention, the microcontroller 200 learns two reference values: when the recess is empty and when the small object intended to be placed in the recess is present. The microcontroller 200 can then differentiate between an empty recess, the small object placed in the recess and another small object according to the value of the impedance and/or of the frequency measured. For a small object that is disposed facing a plurality of sensors, its presence can be characterised by a plurality of reference values for each sensor.

The small object must be a metal conductive object, ferrous or not. The small object may be partially or completely covered with a metal coating.

FIG. 7 is an example of architecture of an electronic card included in the closed space.

Each electronic card comprises a microcontroller 200, N sensors Cap1 to CapN, each sensor Capi, with i=1 to N, consists of an inductor Li and a capacitor Ci. The sensors Capi are connected to a multiplexer consisting of a switch SW1 to SWN and SW′ 1 to SW′N. Each electronic card comprises a module 701 for measuring the parallel impedance of each sensor, a module 702 for measuring the resonant frequency of each sensor, an oscillator circuit 703 and a temperature sensor 704.

FIG. 8 shows an example of an algorithm executed by a microcontroller in the electronic card included in the closed space according to the present invention.

At the step E800, the microcontroller 200 detects the reception of a message from the control device 100 demanding monitoring of the impedance and/or of the frequency of the sensors Cap1 to CapN.

At the step E801, the microcontroller 200 selects an active sensor, for example the sensor CA1, by positioning the switches SW1 and SW′1 in the closed position.

At the step E802, the microcontroller obtains a measurement of the impedance or frequency of the sensor Cap1.

The resistance of the sensor, and therefore the characteristic measured, varies as a function of the temperature of the electronic card. In order to prevent an erroneous detection when a recess is empty, or avoiding an error, a compensation for the temperature is made.

During the configuration process, for each sensor Cap1 to CapN, the microcontroller measures the characteristic (Zref) and records it in the non-volatile memory. At the same time, it measures the reference temperature (Tref) and records it in the non-volatile memory.

By making the inventory, for each sensor, the microcontroller obtains a measurement of the characteristic (Zact) and obtains a measurement of the temperature (Tact).

At the step E803, the microcontroller calculates the compensated reference characteristic (Zcomp), using the equation:

$$Zcomp = Zref * ( 1 + ( Tact - Tref ) * Tcoefft )$$

where Tcoefft is a configuration variable stored in the non-volatile memory. Its value is the result of a series of tests across the operational temperature range.

A small object is determined as being present if:

$$Zact > Zcomp + Tol$$

where Tol is a configuration variable stored in the non-volatile memory. Its value is the result of a series of tests that determines the sensitivity of the detection of the smallest objects.

At the step E804, the microcontroller 200 checks whether all the active sensors have been measured.

If so, the microcontroller 200 passes to the step E806; if not, the microcontroller passes to the step E805, selects another sensor and returns to the step E801.

At the step E806, the microcontroller 200 demands the transfer of a frame comprising, for each active sensor, information representing the detection or not of the presence of the small objects.

1. A system for inventorying objects contained in a closed space delimited by an enclosure, the closed space comprising at least one closed sub-space, the at least one closed sub-space comprising an electronic card on which a mount is placed comprising recesses for receiving objects to be inventoried comprising at least one metallic portion, at least some of the recesses being conformed to receive respectively an object, the system comprising a control device able to determine whether all the objects are included in the closed space, wherein the electronic card comprises a plurality of sensors using eddy-current technology, each sensor consisting of an electronic circuit composed of an inductor and a capacitor, and wherein the electronic card is configured for:
receiving a command from the control device to make measurements,
activating measurements of at least one characteristic of at least one set of electronic circuits composed of an inductor and a capacitor,
activating a comparison of each measured characteristic with a determined reference characteristic for each electronic circuit composed of an inductor and a capacitor,
activating a determination of the presence of an object according to at least one comparison result,
transferring, to the control device, a frame comprising, for each electronic circuit in the set of electronic circuits composed of an inductor and a capacitor, information representing the detection or not of the presence of the small objects.

2. The system according to claim 1, wherein each sensor is respectively disposed on the electronic card at an intersection of a horizontal line and of a vertical line, the vertical and horizontal lines being spaced apart regularly.

3. The system according to claim 2, wherein the system is configured for:
measuring the temperature in the closed sub-space, the reference characteristic determined for each electronic circuit composed of an inductor and a capacitor being obtained from a measurement of the characteristic when the mount comprising recesses is empty,
storing the temperature measured during the measurement of the characteristic when the mount comprising recesses is empty and during the measurement of the characteristic when the mount comprising recesses is empty.

4. The system according to claim 3, wherein the temperature of the closed sub-space is measured during the measurement of the characteristic of at least some of the electronic circuits composed of an inductor and a capacitor, the reference characteristic being determined in accordance with the following formula:
$$Zcomp = Zref * ( 1 + ( Tact - Tref ) * Tcoefft )$$
where Tcoefft is a previously memorised stored configuration variable, Zref is the measurement of the characteristic when the mount comprising recesses is empty, Tref is the temperature measured during the measurement of the characteristic when the mount comprising recesses is empty and Tact is the temperature measured when the means for measuring the characteristic are activated.

5. The system according to claim 1, wherein the control device is connected to a UHF RFID reader disposed on the closed space, wherein the UHF RFID reader is provided with at least one antenna that emits electromagnetic waves intended for RFID tags.

6. The system according to claim 1, wherein the characteristic is a parallel impedance and/or a frequency.

7. A method for inventorying objects contained in a closed space delimited by an enclosure, the closed space comprising at least one closed sub-space, the at least one closed sub-space comprising an electronic card on which a mount is placed comprising recesses for receiving objects to be inventoried comprising at least one metallic portion, at least some of the recesses being conformed to receive respectively an object, the system comprising a control device able to determine whether all the objects are included in the closed space, wherein the electronic card comprises a plurality of sensors using eddy-current technology, each sensor consisting of an electronic circuit composed of an inductor and a capacitor, and in that the method comprises the steps, performed by a microcontroller of the electronic card, of:
receiving a command from the control device to make measurements,
activating measurements of at least one characteristic of at least one set of electronic circuits composed of an inductor and a capacitor,
activating a comparison of each measured characteristic with a determined reference characteristic for each electronic circuit composed of an inductor and a capacitor,
activating a determination of the presence of an object according to at least one comparison result,
transferring, to the control device, a frame comprising, for each electronic circuit in the set of electronic circuits composed of an inductor and a capacitor, information representing the detection or not of the presence of the small objects.
